(19) United States
(12) Patent Application Publication
(10) Pub. No.: US 2026/0359734 A1
(43) Pub. Date: Nov. 12, 2026

(54) ADAPTIVE AND EFFICIENT UNIVERSAL DRAFTER FOR ON-DEVICE SPECULATIVE DECODING IN AUTOREGRESSIVE GENERATIVE ARTIFICIAL INTELLIGENCE MODELS

(71) Applicant: QUALCOMM Incorporated, San Diego, CA (US)

(72) Inventors: Ramchalam KINATTINKARA RAMAKRISHNAN, North York (CA); Zhaocong YUAN, Toronto (CA); Shaojie ZHUO, Richmond Hill (CA); Xiaopeng ZHANG, North York (CA)

(21) Appl. No.: 19/276,795

(22) Filed: Jul. 22, 2025

Related U.S. Application Data
(60) Provisional application No. 63/803,363, filed on May 9, 2025.

(51) Int. Cl. G06N 20/20; G06N 5/01

(52) U.S. Cl. CPC G06N 20/20; G06N 5/01

(57) ABSTRACT

Certain aspects of the present disclosure provide techniques and apparatus for machine learning. In an example method, an input is received at a first generative machine learning model associated with a first vocabulary and being capable of being associated with a plurality of second generative machine learning models, each being associated with a respective second vocabulary. Based on the input, a first token identifier from the second vocabulary associated with an operative second generative machine learning model is mapped to at least one second token identifier associated with the input from the first vocabulary. The operative second generative machine learning model is one of the plurality of second generative machine learning models. A set of draft tokens is generated based on processing the at least one second token identifier using the first generative machine learning model. A response to the input is generated based on the set of draft tokens.

### CROSS-REFERENCE TO RELATED APPLICATION

This application claims the benefit of U.S. Provisional Patent Application Ser. No. 63/803,363, filed May 9, 2025, which is hereby incorporated by reference herein in its entirety for all applicable purposes.

### INTRODUCTION

### Field of the Disclosure

Aspects of the present disclosure relate to machine learning. More specifically, aspects of the present disclosure relate to speculative decoding in generative artificial intelligence models.

### DESCRIPTION OF RELATED ART

A wide variety of machine learning model architectures have been trained to perform an assortment of diverse tasks, including computer vision tasks, language tasks, classification and regression tasks, and the like. Recently, research has yielded substantial success in using large language models (LLMs), large vison models (LVMs), and/or large multimodal models (LMMs) to process and generate output data. Often, machine learning models (especially LLMs, LVMs, and LMMs) have many parameters (e.g., millions or even billions), resulting in significant model size, as well as substantial computational expense and time to generate output using the model.

Some recent efforts to mitigate the computational expense of such generative models include speculative decoding, where a less computationally expensive model (referred to in some aspects as a “draft model”) can be used to generate a subset of the tokens in the output (rather than using the larger model, often referred to as the “target model,” for all tokens).

### BRIEF SUMMARY

Certain aspects of the present disclosure provide a processor-implemented method for machine learning. The processor-implemented method includes receiving an input at a first generative machine learning model. The first generative machine learning model is associated with a first vocabulary. The first generative machine learning model is capable of being associated with a plurality of second generative machine learning models. Each of the plurality of second generative machine learning models is associated with a respective second vocabulary. The processor-implemented method also includes, based on the input, mapping a first token identifier from the second vocabulary associated with an operative second generative machine learning model to at least one second token identifier associated with the input from the first vocabulary. The operative second generative machine learning model is one of the plurality of second generative machine learning models. The processor-implemented method also includes generating a set of draft tokens based on processing the at least one second token identifier using the first generative machine learning model. The processor-implemented method further includes generating a response to the input, based on the set of draft tokens.

Certain aspects of the present disclosure provide a processing system for machine learning. The processing system includes one or more memories comprising processor-executable instructions and one or more processors coupled to the one or more memories. The one or more processors are configured to execute the processor-executable instructions and cause the processing system to: receive an input at a first generative machine learning model, the first generative machine learning model being associated with a first vocabulary, the first generative machine learning model being capable of being associated with a plurality of second generative machine learning models, and each of the plurality of second generative machine learning models being associated with a respective second vocabulary; based on the input, map a first token identifier from the second vocabulary associated with an operative second generative machine learning model to at least one second token identifier associated with the input from the first vocabulary, the operative second generative machine learning model being one of the plurality of second generative machine learning models; generate a set of draft tokens based on processing the at least one second token identifier using the first generative machine learning model; and generate a response to the input, based on the set of draft tokens.

Certain aspects of the present disclosure provide a processing system for machine learning. The processing system includes means for receiving an input at a first generative machine learning model. The first generative machine learning model is associated with a first vocabulary. The first generative machine learning model is capable of being associated with a plurality of second generative machine learning models. Each of the plurality of second generative machine learning models is associated with a respective second vocabulary. The processing system also includes, based on the input, means for mapping a first token identifier from the second vocabulary associated with an operative second generative machine learning model to at least one second token identifier associated with the input from the first vocabulary. The operative second generative machine learning model is one of the plurality of second generative machine learning models. The processing system also includes means for generating a set of draft tokens based on processing the at least one second token identifier using the first generative machine learning model. The processing system further includes means for generating a response to the input, based on the set of draft tokens.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 depicts an example workflow for using a universal draft model to perform speculative decoding, according to certain aspects of the present disclosure.

FIG. 2 depicts an example workflow for performing mapping between token IDs from a target model and token IDs from a draft model, and vice versa, using an intersection of a draft vocabulary and a target vocabulary, according to certain aspects of the present disclosure.

FIG. 3 illustrates a table, which includes an example target vocabulary and an example draft vocabulary, according to certain aspects of the present disclosure.

FIG. 4 depicts an example workflow for performing mapping between token IDs from a target model and token IDs from a draft model, and vice versa, using a non-intersection of a draft vocabulary and a target vocabulary, according to certain aspects of the present disclosure.

FIG. 5 illustrates an example n-gram cache for the target vocabulary and the draft vocabulary depicted in FIG. 3, according to certain aspects of the present disclosure.

FIG. 6 illustrates an example of draft proposals from a draft model, according to certain aspects of the present disclosure.

FIG. 7 depicts an example workflow for performing online adaptation of a draft model for a particular user, task, target model, or a combination thereof, according to certain aspects of the present disclosure.

FIG. 8 depicts an example workflow for performing online adaptation of a draft length for a draft model for a particular user, task, target model, or a combination thereof, according to certain aspects of the present disclosure.

FIG. 9 depicts an example workflow for performing online adaptation using an adaptive drafting tree for a draft model, according to certain aspects of the present disclosure.

FIG. 10 is a flow diagram depicting an example method for machine learning, according to some aspects of the present disclosure.

FIG. 11 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for providing improved machine learning. Specifically, in certain aspects of the present disclosure, techniques for improved speculative decoding using a universal, on-device, draft model capable of interacting (or at least being paired) with multiple different target models for speculative decoding are provided.

Many model architectures, such as large language models (LLMs), large vision models (LVMs), and large multimodal models (LMMs) have shown great promise in generating useful output data. However such generative models are often slow at inference time (e.g., taking substantial time to generate output tokens) and are similarly computationally expensive (e.g., consuming substantial memory, as well as processor time and energy, and resulting in substantial heat generation). As a result, a variety of techniques have been developed to accelerate the token generation rate and/or reduce the computational expense of the token generation. One such technique includes speculative decoding, where a drafting phase is performed to produce “draft” tokens using a relatively less computationally expensive and/or quicker draft model. These draft tokens can then undergo a verification phase to determine whether the draft tokens are “accepted” or “rejected” (e.g., by the target model) to produce the final set of output tokens. Speculative decoding techniques can accelerate (and/or reduce the computational expense associated with) the inference in applications of LLMs for variety of tasks, including text summarization, multi-turn chat, code refactoring, and/or other input-grounded generation tasks.

In some speculative decoding techniques, the draft model may be a pruned version of the target model chosen such that the draft model and target model have similar probability distributions. In other speculative decoding techniques, the draft model may be a smaller version of the target model (e.g., trained on millions of tokens, instead of hundreds of millions or billions of tokens).

One potential drawback with conventional speculative decoding techniques is that such speculative decoding techniques are typically implemented with homogenous systems, where the draft model and the target model are both implemented on the same device (e.g., edge device, such as a portable computing device) or implemented on a cloud computing system, as illustrative examples. In general, there may be a tradeoff between accuracy and privacy depending on whether the draft model and target model are implemented on the same device or on the cloud. On the one hand, implementing both the draft model and the target model on the cloud can introduce privacy concerns for users. For example, exchanging data with cloud-based draft and/or target models may compromise sensitive data and/or user-specific inputs for a given inferencing task. On the other hand, implementing both the draft model and the target model on the same device (e.g., edge device) may introduce accuracy or quality issues with the model output. For example, in some cases, the output of an on-device target model may have somewhat reduced accuracy or quality compared to an off-device target model (e.g., a target model implemented off-device), due in part to the on-device target model having a smaller size and/or lower complexity relative to the off-device target model.

Another potential drawback with conventional speculative decoding techniques is that such speculative decoding techniques generally have issues with diverse input (e.g., when the draft model is introduced to out-of-distribution data). In certain cases, for example, a draft model may be exposed to data from different users and/or data associated with different tasks, where the data for each user may be personalized (or specific) to that user, and the data for a given task may be particularized for that task. In these cases, a draft model trained on a particular user's data and/or data for a particular task may not be able to adapt (online) to another user's data and/or data for another task.

Another potential drawback with conventional speculative decoding techniques is that such speculative decoding techniques typically use a fixed draft length when drafting tokens using the draft model. However, using a fixed draft length during online adaptation can impact (e.g., reduce) the acceptance rate of the draft tokens by the target model, mitigating the efficiency and performance of speculative decoding techniques.

Certain aspects of the present disclosure provide techniques for improved speculative decoding based in part on using a universal, on-device, draft model capable of interacting (or at least being paired) with multiple different target models for speculative decoding. As described herein, a single universal draft model is provided that can run locally on-device and is capable of being paired with multiple different target models. Each of the target models can be run (locally) on-device (e.g., on a hardware accelerator located on-device) or remotely (e.g., on the cloud), e.g., depending on the desired/target efficiency, privacy, and/or model accuracy.

Additionally, in certain aspects described herein, the single universal draft model can adapt dynamically to different types of user data. For example, the single universal draft model can be personalized for different tasks and/or different user preferences online. As described herein, in certain aspects, different low-rank adaptation (LoRA) adapters for different users and/or different tasks may be coupled to the single universal draft model and used to dynamically adapt the single universal draft model for different tasks and/or different user preferences.

Additionally, in certain aspects described herein, an optimized (or at least improved) adaptive drafting scheme is provided for the single universal draft model that enables the single universal draft model to adaptively adjust the draft length for the draft model over time, based on one or more criteria. By adjusting the draft length for the draft model over time, aspects described herein can improve the acceptance rate of draft tokens and compute efficiency of the speculative decoding technique.

The techniques and apparatus described herein for improved speculative decoding using a single universal draft model for speculative decoding may provide various technical advantages. For example, the universal draft model described herein can seamlessly pair with any target model, whether running locally or remotely (e.g., on the cloud), enabling flexible deployment across a wide range of systems and applications. For example, implementing the universal draft model with LoRA modules and online adaptation may allow for the universal draft model to support user-specific personalization and task-specific customization. Additionally, by running the universal draft model locally and minimizing (or at least reducing) the data exchanged with a cloud-based target model, the framework described herein can increase privacy protection for sensitive and/or user-specific inputs.

Additionally, when the universal draft model described herein is paired with a cloud-based target model, the overall system capability can scale beyond local hardware capabilities, enabling high quality results without being constrained by on-device resources. Additionally, by enabling online adaptation of the universal draft model, the overall acceptance rate of the draft model can be improved. Moreover, enabling a contextual adaptive drafting length for the universal draft model can reduce redundant computation, enabling a faster response time and lower power consumption.

In some aspects, as used herein, a “target model” may generally refer to a (primary) generative machine learning model (also referred to as a (primary) “generative artificial intelligence model”) from which output generated data is desired. For example, the target model may correspond to an LLM being used to generate outputs. In some aspects, the target model may incur substantial latency and/or computational expense to generate output tokens (e.g., due to the size of the model). Similarly, as used herein, a “draft model” may generally refer to a smaller and/or less complex (secondary) generative machine learning model (also referred to as a (secondary) “generative artificial intelligence model”) that can be used as a surrogate for the target model in some cases (e.g., generating similar output, potentially with somewhat reduced accuracy or quality). Generally, the draft model may incur less latency and/or computational expense to generate output tokens, as compared to the target model, due to the smaller size and/or lower complexity of the draft model relative to the target model.

Generally, the particular architecture or techniques used to implement the draft model may vary depending on the particular implementation. For example, in some aspects, the draft model may comprise a separate or discrete model from the target model, or may be implemented as a subset of the target model's layers (e.g., where the draft model corresponds to every other layer of the target model). In some aspects, the draft model may be implemented using extra parameters in the target model itself to generate draft tokens.

### Example Speculative Decoding in Generative Artificial Intelligence Models

Generally, autoregressive token generation (e.g., in LLMs) may take historical tokens as an input in order to generate an output. That is, autoregressive token generation may be represented by the expression:

xₜ~p(x|x₀,x₁, . . . ,xₜ₋₁)→xₜ₊₁~p(x|x₀,x₁, . . . ,xₜ₋₁,xₜ)

where xₜ represents a sequence of tokens generated at time t, having a conditional probability p conditioned on the selection of tokens x₀ through xₜ₋₁, and xₜ₊₁ represents a sequence of tokens generated at time t+1, having a conditional probability p conditioned on the selection of tokens x₀ through xₜ. Generally, a single token may be generated each time an autoregressive model is executed, which means that N inferences may be performed to generate a sequence of N tokens. As discussed above, speculative decoding techniques can be used to accelerate token generation by using a draft model, smaller in size than the target model, that speculatively generates tokens, with the target model being used to verify the tokens (speculatively) generated by the draft model.

In a speculative decoding pipeline, the draft model may speculatively generate n tokens autoregressively, according to the expression:

$${x}_{t + 1}^{draft} ∼ {p}_{t}^{draft} = {p}^{draft} ( x \vert {x}_{0} , … {x}_{t} ) , {x}_{t + 2}^{draft} ∼ {p}_{t + 1}^{draft} , … , {x}_{t + n}^{draft} ∼ {p}_{t + n - 1}^{draft}$$

where t corresponds to a point in time and

$${p}_{t}^{draft}$$

corresponds to the conditional probability distribution associated with a selected token x at time t conditioned on the selection of tokens x, through xₜ₋₁.

The target model takes the generated n tokens and processes the n tokens in parallel to generate probability distributions for each of the n tokens, according to the expression:

$$[ {p}_{t}^{target} , {p}_{t + 1}^{target} , … , {p}_{t + n}^{target} ] = {[ {p}^{target} ( x \vert {x}_{0} , … {x}_{t} , {x}_{t + 1}^{draft} , … , {x}_{t + k}^{draft} ) ]}_{k = 1 , 2 , … , n}$$

where k corresponds to a token index relative to the generated n tokens.

The target model can then verify the tokens generated by the draft model by comparing distributions from the draft model and target model to determine whether a token is accepted or rejected. A given token

$${x}_{t + k}^{draft}$$

may be accepted when

$$f ( {p}_{k}^{draft} , {p}_{k}^{target} ) < α ,$$

for some function ƒ and some threshold α (also known as an acceptance rate). Otherwise, the token may be rejected. The final token may then be generated at the first rejection position or at the last position n based on some function

$$g ( {p}_{k}^{draft} , {p}_{k}^{target} ) .$$

Speculative decoding, with an acceptance rate of a, may result in cost reductions relative to using a single autoregressive model to generate tokens iteratively. Inference cost savings, relative to iterative token generation, may be represented by the expression:

$${C}^{AR} = {NC}^{target} \to {C}^{SD} = {nNC}^{draft} + \frac{N}{α + 1} {C}^{target}$$

Consider the example, for N=1000, C^{target}=10, C^{draft}=1, n=4, α=3, wherein N corresponds to a number of tokens, C^{AR} corresponds to a computational cost of generating an inference using an autoregressive (AR) model, a corresponds to an acceptance rate, C^{target} corresponds to a computational cost of generating a set of tokens using the target model, C^{SD} corresponds to a computational cost of speculative decoding (SD), C^{draft} corresponds to a computational cost of generating a set of tokens using the draft model, and n corresponds to a number of tokens generated speculatively generated tokens generated through a single pass through an autoregressive model. In such an example, speculative decoding may result in a 35% reduction in computational expense relative to autoregressive iterative token generation alone.

However, as discussed, in some speculative decoding techniques, the reduction in computational expense (relative to autoregressive iterative token generation) that may be achieved by speculative decoding may be mitigated (at least somewhat) by introducing the draft model to diverse input (e.g., out-of-distribution data) that is associated with a given user and/or given task. For example, the speedup factor of conventional speculative decoding techniques may rely on the predictability of the generated output (e.g., commonly occurring phrases), as well as the alignment between the draft and target model. As such, some speculative decoding techniques generally utilize draft and target models from the same model family given their consistency in pretrained data, tokenization, and training configurations. This tight coupling of draft and target models, however, can limit the flexibility of the draft model to diverse input. For example, when introduced to such diverse input, the draft model may be unable to adapt to the diverse input online, compromising the accuracy or quality of the output token generation, as well as increasing the latency and/or computational expense of the token generation, in some instances.

### Efficient Workflow for Using a Universal Draft Model to Perform Speculative Decoding

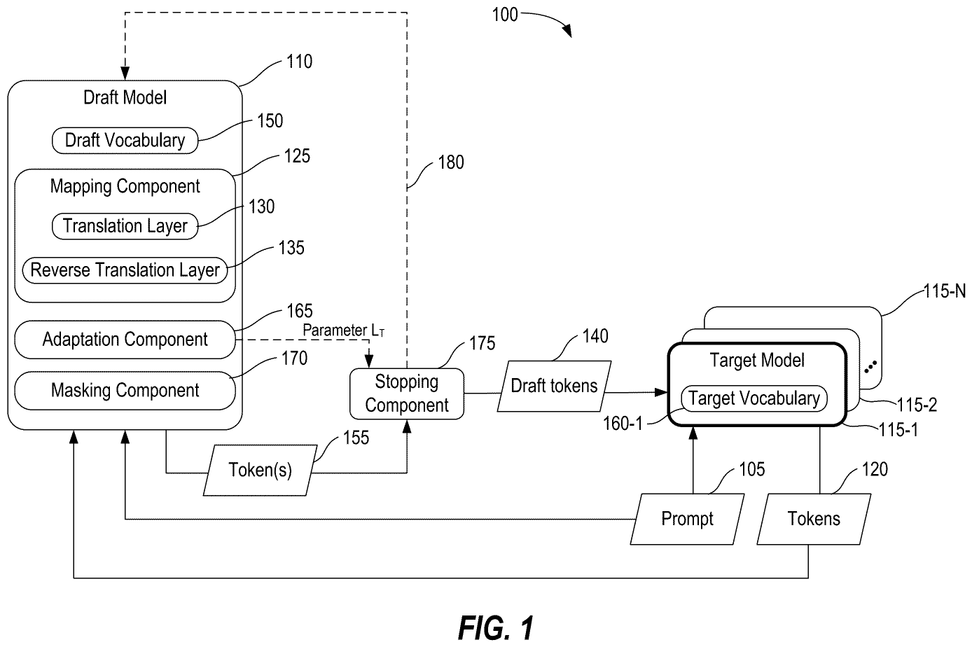

FIG. 1 depicts an example workflow 100 for using a universal draft model to perform speculative decoding, according to certain aspects of the present disclosure. In certain aspects, the workflow 100 is performed by a speculative decoding system. That is, the workflow 100 may be performed by any computing system configured to perform speculative decoding, as discussed above and herein. In the depicted workflow 100, the draft model 110 is a universal draft model that is capable of interacting (or at least being paired) with multiple target models 115-1 to 115-N to perform various tasks.

In certain aspects, the workflow 100 may be performed by multiple discrete systems. For example, one computing system (e.g., a portable device) may implement the draft model 110, while one or more other computing systems (e.g., one or more servers) may implement the target models 115-1 to 115-N. In other aspects, the same computing system (e.g., a portable device) may implement the draft model 110 and the target models 115-1 to 115N. In yet other aspects, one computing system (e.g., a portable device) may implement the draft model 110 and at least one of the target models 115 (e.g., the target model 115-1), while one or more other computing systems (e.g., one or more servers) may implement the remaining target models 115 (e.g., the target models 115-2 to 115-N).

In the depicted workflow 100, each target model 115 (also referred to in some aspects as the “primary model,” the “primary machine learning model,” and/or the “primary generative machine learning model”) generally corresponds to a generative machine learning model used to generate output data based on input prompts. For example, as discussed above, one or more of the target models 115 may correspond to an LLM, LVM, LMM, or the like. In some aspects, each target model 115 may be relatively computationally expensive (e.g., incurring substantial latency and/or computational resource usage) during runtime. Further, in the illustrated example, the draft model 110 (also referred to in some aspects as the “secondary model,” the “secondary machine learning model,” and/or the “secondary generative machine learning model”) generally corresponds to a generative machine learning model that can also be used to generate output data based on input prompts. In some aspects, as discussed above, the draft model 110 may be relatively less computationally expensive than each target model 115 (e.g., incurring less latency and/or computational resource usage, as compared to the target model 115) during runtime.

In the illustrated example, the draft model 110 includes (or is otherwise associated with) a draft vocabulary 150. For example, the draft model 110 may generate one or more draft tokens 140 based on the draft vocabulary 150. Additionally, each target model 115 includes (or is otherwise associated with) a respective target vocabulary 160 (e.g., target model 115-1 includes the target vocabulary 160-1, target model 115-2 includes the target vocabulary 160-2, and so on). Each target model 115 may generate one or more tokens 120 based on the respective target vocabulary 160 for that target model 115. While draft vocabulary 150 is depicted within the draft model 110 for conceptual clarity, in certain aspects, the draft vocabulary 150 may not be included as part of the draft model 110 and may be implemented elsewhere, e.g., on the same or different computing device as the draft model 110. Similarly, while each target vocabulary 160 is depicted within the respective target model 115 for conceptual clarity, in certain aspects, the target vocabulary 160 may not be included as part of the respective target model 115 and may be implemented elsewhere, e.g., on the same or different computing device as the respective target model 115.

In certain aspects, the draft vocabulary 150 may be different from each of the target vocabularies 160. For example, the draft vocabulary 150 may include a different set of tokens (and corresponding token identifiers (IDs)) than each of the target vocabularies 160. In other aspects, the draft vocabulary 150 may be the same as at least one of the target vocabularies 160. For example, the draft vocabulary 150 may include a same set of tokens (and corresponding token IDs) as at least one of the target vocabularies 160.

In the illustrated example, a prompt 105 (also referred to in some aspects as a “query”) is accessed by the draft model 110 and one of the target models 115 (e.g., target model 115-1) (also referred to in some aspects as the “operative target model,” the “operative primary model,” the “operative primary machine learning model,” and/or the “operative primary generative machine learning model”). As used herein, “accessing” data may generally include receiving, retrieving, obtaining, collecting, generating, or otherwise gaining access to the data. For example, the prompt 105 may be received from a user or entity that uses the machine learning model(s) to generate output. Generally, the particular content and format of the prompt 105 may vary depending on the particular implementation. For example, in some cases, the prompt 105 may comprise textual information (e.g., natural language text) for use as input to an LLM to generate textual output (e.g., a natural language text response).

In some aspects, the workflow 100 may use the target model 115-1 as the operative target model, based at least in part on the particular inferencing task, particular user of the speculative decoding system, or a combination thereof. However, while certain aspects described herein use the target model 115-1 as a reference example of an operative target model, note that any of the target models depicted in FIG. 1 may be used as the operative target model.

In some aspects, the draft model 110 may be somewhat less accurate or reliable than the target model 115-1 (as well as the other target models 115-2 to 115-N). However, not all tokens in a generated output are equally “difficult” to generate. Therefore, in some aspects, the draft model 110 may be reliably used to generate some tokens, even if the target model 115-1 is relied upon for other tokens. Knowing the “difficulty” of a given token (before drafting the token) is, generally speaking, nearly impossible. In some aspects, therefore, the depicted workflow 100 can be used to implement speculative decoding. Generally, as discussed above, speculative decoding involves using the target model 115-1 to generate some set of tokens in the output, while allowing the draft model 110 to generate another set of one or more tokens. These tokens generated by the draft model 110 (referred to as “draft tokens” in some aspects) can then be evaluated (e.g., using the target model 115-1) to verify the draft tokens. That is, the target model 115-1 may accept one or more of the draft tokens, and the target model 115-1 may reject one or more of the draft tokens (e.g., because the token is too dissimilar from what the target model 115 would have generated).

In some aspects, because the draft model 110 is less computationally complex than the target model 115-1, the set of draft tokens can be generated more rapidly and with less computational expense, as compared to generating the set using the target model 115-1 alone. Further, because the target model 115-1 may evaluate multiple draft tokens in parallel (e.g., evaluating the entire sequence of draft tokens at once), the target model 115-1 can be used to quickly verify the draft tokens. By combining these features, the workflow 100 can substantially accelerate the output generation process.

In the illustrated example, the target model 115-1 may process the prompt 105 to generate a set of one or more tokens 120. As used herein, a “token” corresponds to a unit of output of the model(s). Generally, the particular format and content of a token may vary depending on the particular implementation. For example, in some aspects, the tokens 120 comprise words, phrases, alphanumeric characters and/or symbols, and the like. Generally, the particular number of tokens 120 to be generated using the target model 115 may vary depending on the particular implementation. For example, in some aspects, the computing system may generate a single token 120 using the target model 115 in between each drafting phase (e.g., before using the draft model 110). As another example, the computing system may use the target model 115 to generate two or more tokens 120 between drafting phases. In yet another example, the computing system may not generate any tokens using the target model 115, e.g., prior to using the draft model 110. In certain aspects, the tokens 120 may be generated in part based on a target vocabulary 160-1 associated with the target model 115-1. For example, each of the tokens 120 may be associated with a respective token ID within the target vocabulary 160-1.

In the illustrated workflow 100, these initial tokens 120 are provided, along with the prompt 105, to the draft model 110, to generate a new set of one or more tokens 155. In some aspects, as discussed above, the tokens 155 may be referred to as “draft” tokens to indicate that the tokens 155 were generated by the draft model 110. Generally, the particular number of tokens 155 to be generated using the draft model 110 may vary depending on the particular implementation.

In the illustrated workflow, the draft model 110 includes a mapping component 125, which may be implemented with hardware, software, or combinations thereof. In certain aspects, the mapping component 125 is generally configured to map token IDs within the target vocabulary 160-1 for a set of tokens to token IDs within the draft vocabulary 150 for the set of tokens, and vice versa. The draft model 110 may use the mapping component 125 in cases where the draft model 110 and the target model 115-1 do not share the same tokenizer and same vocabulary (e.g., the draft vocabulary 150 and the target vocabulary 160-1 are different).

In such cases where the draft model 110 and the target model 115-1 have different tokenizers and different vocabularies, the mapping component 125 may use a translation layer 130 to map (target) token IDs within the target vocabulary 160-1 for the tokens 120 to (draft) token IDs within the draft vocabulary 150. After this translation, the draft model 110 may use the draft token IDs to generate the new set of tokens 155. Additionally, in certain aspects, the mapping component 125 may use a reverse translation layer 135 to map the draft token IDs for the tokens 155 to target token IDs within the target vocabulary 160-1. After this reverse translation, the draft model 110 may provide draft tokens 140 (corresponding to the target token IDs for the tokens 155) to the target model 115-1 for verification.

In certain aspects, the mapping component 125 (including the translation layer 130 and/or the reverse translation layer 135) may perform mapping using an n-gram cache that tracks the instances of target-draft token translations. For example, given target tokens tᵢ∈ target vocabulary (Vₚ) and draft tokens di E draft vocabulary (V_{q}), the n-gram cache (C) may have the following representation in Equation (1):

$$C = \{ {t}_{i} , {[ {d}_{j}^{i} ]}_{j = 1 : n} \} \qquad ( 1 )$$

where each element represents a mapped n-gram instance given the matching context so far

$${ctx}_{q} , {d}_{1}^{i} , {d}_{2}^{i} , … , {d}_{n}^{i} = {tokenize}_{q} ( {detokenize}_{p} ( {ctx}_{p} , {t}_{i} ) ) .$$

During inference time, the translation layer 130 may scan over the proposed draft tokens dₜ, . . . , dₜ₊ₖ₋ₗ and merge sub-tokens that hit the n-gram cache. The resulting new sequence tₜ, . . . , tₜ₊ₘ and their draft probabilities \hat{q}(tₜ), . . . , \hat{q}(tₜ₊ₘ) may be in the target vocabulary space and follow the mapping rule in Equation (2):

$${t}_{i} , {q}^{′} ( {t}_{i} ) = \{ \begin{matrix}{d}_{i} & if direct mapping , {t}_{i} ↔ {d}_{i} \\ lookup ( {[ {d}_{j}^{i} ]}_{j = 1 : n} , C ) , {\prod }_{j} q ( {d}_{j}^{i} ) & otherwise\end{matrix} \qquad ( 2 )$$

The cross-vocabulary mapping performed in accordance with Equation (2) translates the draft sequence to the target vocabulary space, ensuring that speculative decoding functions well with per-token acceptance ratios min (1, p(tₜ₊ᵢ)/\hat{q}(tₜ₊₊ᵢ)). From the perspective of the final matched text, p(tᵢ) and

$${\prod }_{j} q ( {d}_{j}^{i} )$$

may be the probability of producing that set of text in their respective tokenization space.

In some cases, however, the mapping component 125 may use the full distribution for the residual distribution instead of point-wise evaluation of probabilities. In such cases, the mapping rule in Equation (3) (as opposed to Equation (2)) may be followed:

$$∀ t ∈ {V}_{p} , {q}^{′} ( t ) = \{ \begin{matrix}{\prod }_{j} q ( {d}_{j}^{i} ) \\ q ( {d}_{j}^{i} ) - {\prod }_{j} q ( {d}_{j}^{i} ) \\ q ( t )\end{matrix} \qquad ( 3 )$$

where

$${q}^{′} ( t ) = {\prod }_{j} q ( {d}_{j}^{i} )$$

if n-gram mapped and

$$t ↔ {[ {d}_{j}^{i} ]}_{j = 1 : n} , {q}^{′} ( t ) = q ( {d}_{j}^{i} ) - {Π}_{j} q ( {d}_{j}^{i} )$$

if prefix sub-token of n-gram,

$$t = {d}_{j}^{i} ,$$

and \hat{q}(t)=q(t) otherwise. In Equation (3), the mapped probability for the selected n-gram is used, but the prefix sub-token probability is adjusted by subtracting the n-gram probability. That is, the mapping rule in Equation (3) may approximately re-allocate the original probability mass assigned to prefix sub-token

$${d}_{j}^{i}$$

under the draft distribution q(·), between the “new” n-gram token and the prefix sub-token under the modified draft distribution \hat{q}(·).

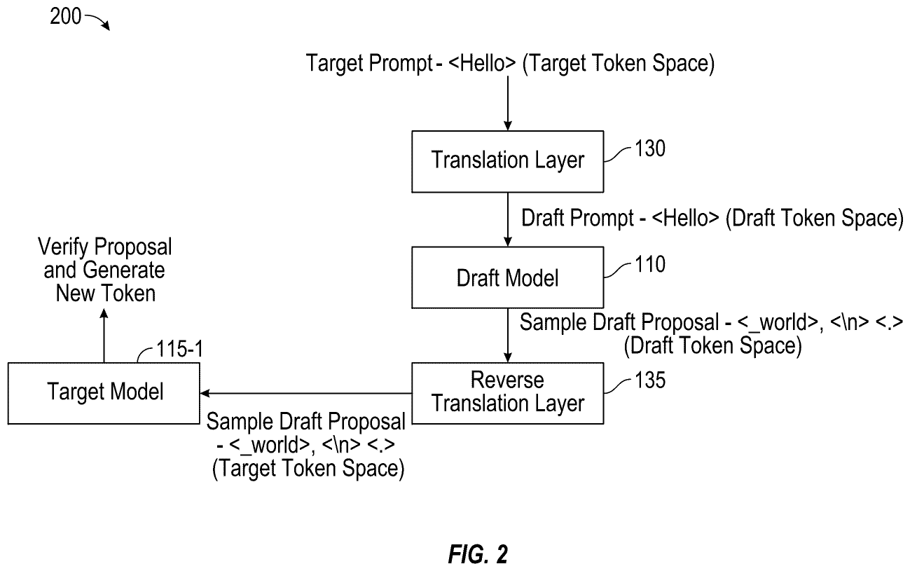

In certain aspects described in greater detail below, the mapping component 125 may perform mapping using an intersection of the draft vocabulary 150 and the target vocabulary 160-1. Note that the mapping component performing mapping using an intersection of the draft vocabulary 150 and the target vocabulary 160-1 is described in greater detail herein with respect to FIG. 2.

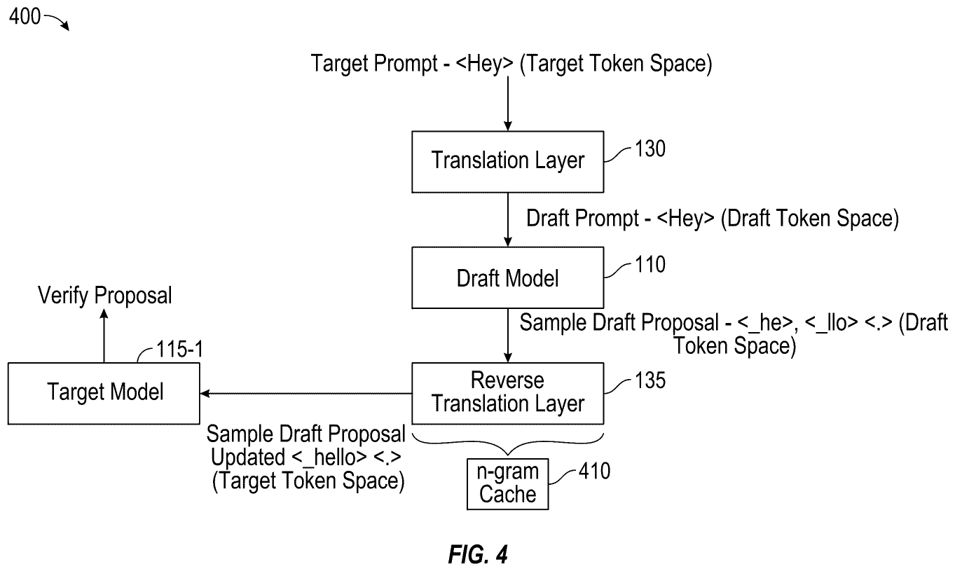

In other certain aspects described in greater detail below, the mapping component 125 may perform mapping using a non-intersection of the draft vocabulary 150 and the target vocabulary 160-1. Note that the mapping component performing mapping using a non-intersection of the draft vocabulary 150 and the target vocabulary 160-1 is described in greater detail herein with respect to FIG. 4.

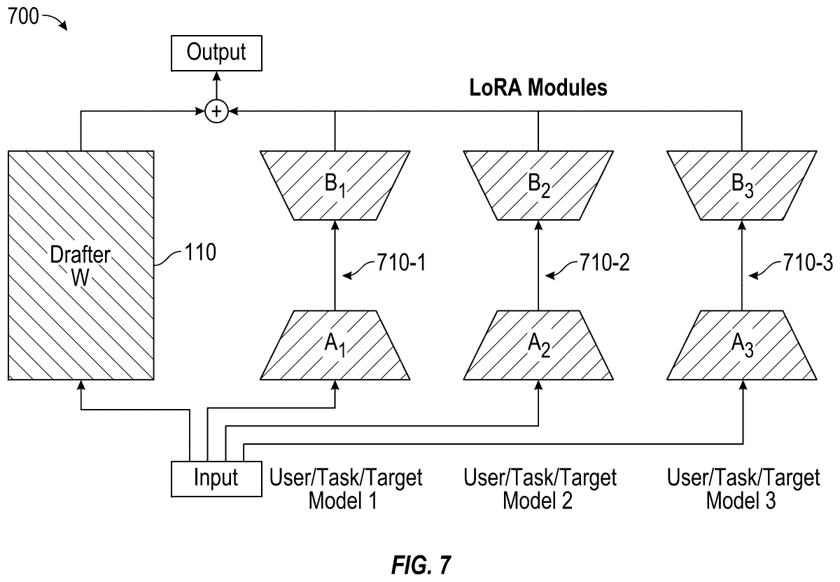

In the illustrated workflow 100, the draft model 110 also includes an adaptation component 165, which may be implemented with hardware, software, or combinations thereof. In certain aspects, the adaptation component 165 may be configured to perform online adaptation of the draft model 110 to adapt the draft model 110 to a particular user's data and/or data associated with a particular task (e.g., inferencing task). For example, the draft model 110 may include one or more LoRA modules/adapters, each associated with a given user, task, target model 115, or a combination thereof. One or more weights of the LoRA module/adapter associated with the target model 115-1 may updated based on input received at the draft model 110, e.g., while the draft model 110 is online. Note that the adaptation component 165 performing online adaptation of the draft model 110 for a given user/task/target model is described in greater detail herein with respect to FIG. 7.

In the illustrated workflow 100, the token(s) 155 are accessed by a stopping component 175 to determine whether to stop the drafting phase. As used herein, stopping the drafting phase (also referred to in some aspects as “exiting” from the drafting phase and/or from the draft model) generally corresponds to determining to use the target model 115-1 for the next one or more token(s) of the output, rather than using the draft model 110 for the next token(s). The stopping component 175 may use a variety of criteria to determine when to exit the drafting phase. For example, the stopping component 175 may determine whether the current sequence of draft tokens (generated by the draft model 110 during the current drafting phase) meets a defined maximum draft length hyperparameter LT (e.g., a defined maximum number of draft tokens that should be generated in a given drafting phase) associated with the target model 115-1. Note that, in certain aspects, each target model 115 may be associated with a respective maximum draft length hyperparameter LT. If the current sequence of draft tokens meets the defined maximum draft length hyperparameter for the target model 115-1, then the stopping component 175 may stop the drafting phase; otherwise, the stopping component 175 may continue the drafting phase, as illustrated by the dotted arrow 180.

In the illustrated workflow 100, if the stopping component 175 determines to continue the drafting phase, as illustrated by the dotted arrow 180, then the draft model 110 may be prompted to generate a next token 155 (e.g., using the prompt 105, the tokens 120, and/or the previously generated token 155 as input). This process can then be repeated until the one or more stopping criteria are satisfied.

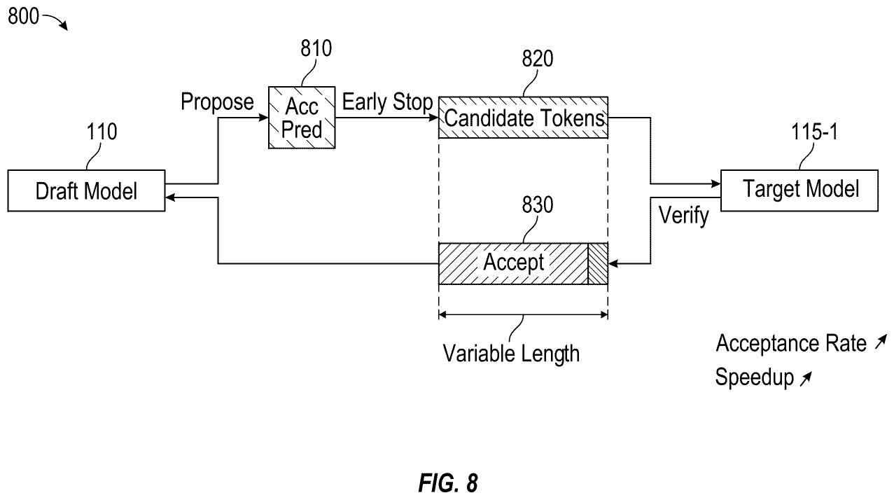

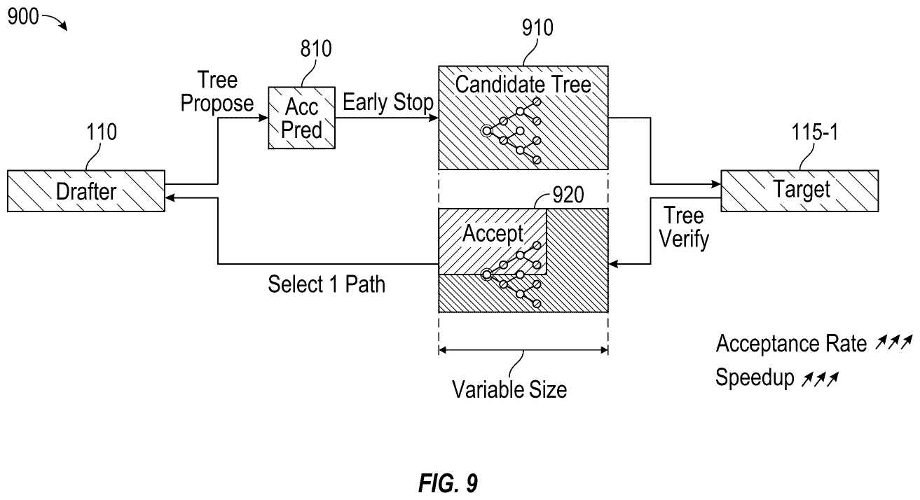

In certain aspects, the adaptation component 165 may be configured to adaptively adjust a draft length for the draft model 110 while the draft model 110 is online. That is, in certain aspects, the adaptation component 165 may be configured to adjust the maximum draft length hyperparameter LT associated with the target model 115-1 during the online operation of the draft model 110. As described in greater detail below, the adaptation component 165 may adjust LT associated with the target model 115-1 based on a likelihood of the target model 115-1 accepting the draft tokens, e.g., in a verification stage. In this manner, aspects allow the draft model 110 to operate using a dynamic draft length, maximizing (or at least increasing) the acceptance rate while still confirming to the speculative decoding framework. Note that the adaptation component 165 performing online adjustment of the draft length a given user/task/target model is described in greater detail herein with respect to FIGS. 8-9.

In the illustrated workflow 100, if the stopping component 175 determines to stop the drafting phase, then the set of generated draft tokens 140 (corresponding to tokens 155) is provided for verification to the target model 115-1. That is, for each iteration of drafting, the draft model 110 may generate and add a new token to the sequence of draft tokens 140 (e.g., adding the highest-scored token at each iteration). Each draft token 140 may include a respective token ID within the target vocabulary 160-1 that is determined/mapped via the mapping component 125. When the drafting phase terminates, this sequence of draft tokens 140 may be provided to the target model 115-1.

In the illustrated workflow 100, the draft model 110 also includes a masking component 170, which may be implemented with hardware, software, or combinations thereof. In certain aspects, the masking component 170 may be configured to mask one or more of the draft tokens 140 prior to providing the draft tokens 140 to the target model 115-1 for verification. The masking component 170 may employ any suitable masking technique to mask the draft tokens 140, including substitution, scrambling, hashing, and nulling, as illustrative examples. In some aspects, the masking component 170 can apply differentiable privacy techniques to add random noise or sampling uncertainty when generating draft tokens 140. Additionally or alternatively, in certain aspects, the masking component 170 may be configured to (pre-) process the input to the draft model 110 (e.g., tokens 120, prompt 105, and/or the previously generated token(s) 155) in order to remove/mask sensitive information. By way of example, assuming the prompt 105 includes “my address is 123 Main Street,” then the masking component 170 may process the prompt 105 so that the prompt 105 includes “my address is [ADDRESS],” prior to using the prompt 105 to generate draft tokens.

In some aspects, as discussed above, the target model 115-1 may be used to verify the draft tokens 140. For example, the prompt 105, any tokens 120 that have already been generated by the target model 115-1, and/or the set of draft tokens 140 may be provided as input, allowing the target model 115-1 to verify (e.g., accept) or reject each token of the sequence of draft tokens 140. For example, the target model 115-1 may generate a score for each token in the sequence of draft tokens 140, accepting tokens having a score above a threshold (e.g., indicating a higher probability that the target model 115-1 would have generated the same token) and rejecting tokens having a score below the threshold (e.g., indicating a low probability that the target model 115-1 would have generated the same token).

In some aspects, this verification process also results in generation of a new next token 120 to be added to the sequence of (accepted) tokens. As illustrated, this updated sequence of tokens can then be provided to the draft model 110 to begin the next drafting phase, as discussed above. Although the illustrated example suggests that the target model 115-1 is used to generate the first token(s) in the output sequence, in some aspects, the draft model 110 may be used to generate the first token(s) (followed by verifying the first token(s) with the target model 115-1).

### Example Workflow for Performing Mapping Using an Intersection of a Draft Vocabulary and a Target Vocabulary

FIG. 2 depicts an example workflow 200 for performing mapping between token IDs from a target model and token IDs from a draft model, and vice versa, using an intersection of a draft vocabulary (e.g., the draft vocabulary 150) and a target vocabulary (e.g., the target vocabulary 160-1), according to certain aspects of the present disclosure. In some aspects, the workflow 200 is performed by a computing system (e.g., a speculative decoding system), such as the computing system discussed above with reference to FIG. 1. In some such aspects, the workflow 200 is performed by one or more components of the computing system, such as the mapping component 125 of the draft model 110 discussed above with reference to FIG. 1.

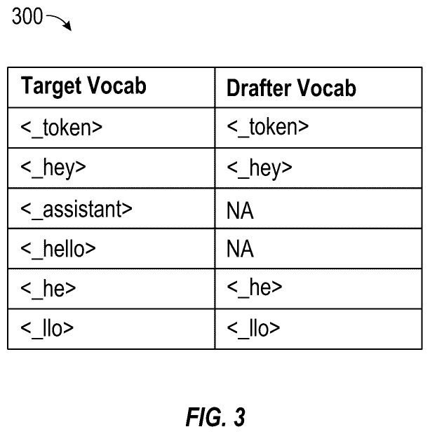

In the illustrated workflow 200, the draft model 110 may be configured to perform mapping using an intersection of the draft vocabulary 150 and the target vocabulary 160-1. By way of example, FIG. 3 illustrates a table 300, which includes an example target vocabulary 160-1 and an example draft vocabulary 150, according to certain aspects of the present disclosure. In particular, the target vocabulary 160-1 depicted in FIG. 3 includes the following tokens: <_token>, <_hey>, <_assistant>, <_hello>, <_test>, and <_llo>. The draft vocabulary 150 depicted in FIG. 3 includes the following tokens: <_token>, <_hey>, <_test>, and <_llo>. Given the target vocabulary 160-1 and the draft vocabulary 150 depicted in FIG. 3, the intersection may include the following tokens: <_token>, <_hey>, <_test>, and <_llo>. Note, each token within the target vocabulary 160-1 may be associated with a respective token ID and each token within the draft vocabulary 150 may be associated with a respective token ID. In some cases, a token that is the same in the target vocabulary 160-1 and the draft vocabulary 150 may or may not have the same token ID. For instance, token <_hey> in the target vocabulary 160-1 may have a token ID X and token <_hey> in the draft vocabulary 150 may have a token ID Y, where X may or may not be equal to Y.

When performing mapping using an intersection of the draft vocabulary 150 and the target vocabulary 160-1, the draft model 110 may perform direct mapping between token IDs in the target vocabulary 160-1 and token IDs in the draft vocabulary 150, and vice versa. In the illustrated workflow 200, for example, the translation layer 130 may receive (or otherwise access) a target prompt that includes the token <Hello> in the target vocabulary 160-1 (e.g., target token space). Here, the translation layer 130 may perform a direct mapping from the token ID for <Hello> in the target vocabulary 160-1 to the token ID for <Hello> in the draft vocabulary 150 (e.g., draft token space), assuming the token <Hello> is in the intersection of the draft vocabulary 150 and the target vocabulary 160-1.

The translation layer 130 may provide a draft prompt that includes the token <Hello> (and associated token ID) in the draft vocabulary 150 to the draft model 110. The draft model 110 may process the token <Hello> (and associated token ID) in the draft vocabulary 150 to generate a sample draft proposal that includes tokens that are in the intersection of the draft vocabulary 150 and the target vocabulary 160-1. Here, for example, the draft model 110 generates a draft proposal including tokens <_world>, <\n>, and <.> (and associated token IDs) in the draft vocabulary 150, and provides the sample draft proposal to the reverse translation layer 135. The reverse translation layer 135 may perform a direct mapping from the respective token IDs for <_world>, <\n>, and <.> in the draft vocabulary 150 to respective token IDs for <_world>, <\n>, and <.> in the target vocabulary 160-1. The reverse translation layer 135 may provide a sample draft proposal including these tokens in the target vocabulary 160-1 to the target model 115-1 for verification.

### Example Workflow for Performing Mapping Using a Non-Intersection of a Draft Vocabulary and a Target Vocabulary

FIG. 4 depicts an example workflow 400 for performing mapping between token IDs from a target model and token IDs from a draft model, and vice versa, using a non-intersection of a draft vocabulary (e.g., the draft vocabulary 150) and a target vocabulary (e.g., the target vocabulary 160-1), according to certain aspects of the present disclosure. In some aspects, the workflow 400 is performed by a computing system (e.g., a speculative decoding system), such as the computing system discussed above with reference to FIG. 1. In some such aspects, the workflow 400 is performed by one or more components of the computing system, such as the mapping component 125 of the draft model 110 discussed above with reference to FIG. 1.

As noted, in certain aspects, the draft model 110 may be configured to perform mapping using a non-intersection of the draft vocabulary 150 and the target vocabulary 160-1. By way of example, assume that the target vocabulary 160-1 includes the token <_hello>, but the draft vocabulary 150 does not include the token <_hello>. In such an example, the draft model 110 may represent the target token <_hello> as a composition of multiple draft tokens in the draft vocabulary 150. For instance, assuming the target vocabulary 160-1 includes <_hello> and the draft vocabulary includes <_he> and <_llo>, then the draft model 110 may represent the target token <_hello> as a composition of the draft tokens <_he> and <_llo>.

In certain cases, however, if the draft model 110 proposes <_he> and <_llo> as two tokens in a direct mapping approach (e.g., similar to the workflow 200 of FIG. 2), then the target model 115-1 may reject one or more of the two tokens. To address this, the draft model 110 may (re) combine the two tokens <_he> and <_llo> into <_hello> to increase the likelihood of the token <_hello> being accepted/verified by the target model 115-1. In certain aspects, to implement mapping using a non-intersection of the draft vocabulary 150 and the target vocabulary 160-1, the draft model 110 may include (or otherwise access) a respective n-gram cache 410 associated with the target model 115-1. Such an n-gram cache for the target model 115-1 may include n-gram mappings of compositions of tokens/token IDs in the draft vocabulary 150 to tokens/token IDs in the target model 115-1. Note the draft model 110 may include a respective n-gram cache for each target model 115-1 to 115-N. In this manner, aspects allow the draft model 110 to be paired with various target models for different users, tasks, applications, etc.

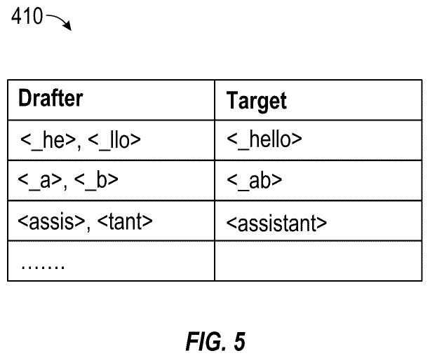

By way of example, FIG. 5 illustrates an example n-gram cache 410 for the target vocabulary 160-1 and the draft vocabulary 150 depicted in FIG. 3, according to certain aspects of the present disclosure. As shown, the n-gram cache 410 includes a first n-gram mapping of a composition of tokens <_he> and <_llo> in the draft vocabulary 150 to the token <_hello> in the target vocabulary 160-1, a second n-gram mapping of a composition of tokens <_a> and <_b> in the draft vocabulary 150 to the token <_ab> in the target vocabulary 160-1, and a third n-gram mapping of a composition of tokens <assis> and <tant> in the draft vocabulary 150 to the token <assistant> in the target vocabulary 160-1, among other n-gram mappings (not shown).

In certain aspects, the n-gram cache may be populated during training of the draft model 110. The n-gram mappings that are included within the n-gram cache for a given target vocabulary 160-1 may be based in part on the probability of the composition of the draft tokens being within a threshold difference of the probability of the target token. For example, for the target token <hello>, the n-gram cache may be populated with <he> and <llo> when P(hello|ctx)~q(he|ctx).q(llo|ctx, he). The training loss may ensure that q(he|ctx).q(llo|ctx, he) increases for this particular setting.

In the illustrated workflow 400, the translation layer 130 may receive (or otherwise access) a target prompt that includes the token <Hey> in the target vocabulary 160-1 (e.g., target token space). Here, the translation layer 130 may perform a direct mapping from the token ID for <Hey> in the target vocabulary 160-1 to the token ID for <Hey> in the draft vocabulary 150 (e.g., draft token space), assuming the token <Hey> is in the intersection of the draft vocabulary 150 and the target vocabulary 160-1. Note, however, that while the workflow 400 depicts the translation layer 130 performing a direct mapping between the target vocabulary 160-1 and the draft vocabulary 150, in certain aspects, the translation layer 130 may perform translation using an n-gram mapping of a composition of tokens within the draft vocabulary 150 to the token <Hey> in the target vocabulary 160-1, e.g., assuming the token <Hey> is not included in the intersection of the target vocabulary 160-1 and the draft vocabulary 150.

The translation layer 130 may provide a draft prompt that includes the token <Hey> (and associated token ID) in the draft vocabulary 150 to the draft model 110. The draft model 110 may process the token <Hey> (and associated token ID) in the draft vocabulary 150 to generate a sample draft proposal that includes one or more tokens that are not included in the intersection of the target vocabulary 160-1 and the draft vocabulary 150. Here, for example, the draft model 110 generates a draft proposal including tokens <_he>, <_llo>, and <.> (and associated token IDs) in the draft vocabulary 150, and provides the sample draft proposal to the reverse translation layer 135.

The reverse translation layer 135 may perform translation using an n-gram mapping of a composition of the tokens <_he> and <_llo> (and associated token IDs) in the draft vocabulary 150 to the token <_hello> (and associated token ID) in the target vocabulary 160-1. The reverse translation layer 135 may access an n-gram cache 410 associated with the target model 115-1 to determine which n-gram mapping is associated with the target token <_hello>. The reverse translation layer 135 may provide a sample draft proposal including an updated set of tokens <_hello> and <.> in the target vocabulary 160-1 to the target model 115-1 for verification.

In certain aspects, depending on the draft proposals, there may be different training losses for training the draft model 110, e.g., for fine-tuning online. In some cases, the training loss may be determined according to Equation (4) when direct mapping is performed, e.g., as described in the workflow 200 of FIG. 2. In other cases, the training loss may be determined according to Equation (5) when composite mapping is performed, e.g., as described in the workflow 400 of FIG. 4. L₁ and L₂ may be represented as follows:

L₁=D_{KL}(p(·|x)∥q(·|x)); for all direct mapping tokens (4)

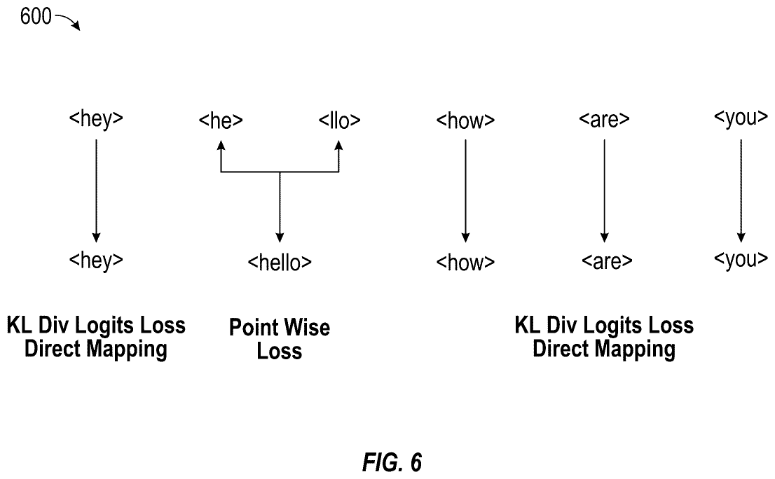

L₂=Σ_{i,k,l}D_{KL}(p(x,i)∥q(x,k:l)); for all the cases that involve point-wise, like<hello> and <he>+<llo> (5)

where D_{KL} is the Kullback-Leibler (KL) divergence, which is a measure of how much a model probability distribution q (e.g., draft model) is different from a true probability distribution p (e.g., target model). As shown in the example 600 of FIG. 6, given a draft proposal that includes direct mapped tokens <hey>, <how>, <are>, and/or <you>, the training loss may be determined according to Equation (4). On the other hand, given a draft proposal that includes point-wise composite mapping, the training loss may be determined according to Equation (5).

### Example Workflow for Performing Online Adaptation of the Draft Model for a Particular User/Task/Target Model

FIG. 7 depicts an example workflow 700 for performing online adaptation of a draft model (e.g., the draft model 110) for a particular user, task, target model, or a combination thereof, according to certain aspects of the present disclosure. In some aspects, the workflow 700 is performed by a computing system (e.g., a speculative decoding system), such as the computing system discussed above with reference to FIG. 1. In some such aspects, the workflow 700 is performed by one or more components of the computing system, such as the adaptation component 165 of the draft model 110 discussed above with reference to FIG. 1.

In the illustrated workflow 700, one or more LoRA modules 710-1 to 710-3 may be included within (or otherwise coupled to) the draft model 110 to adapt the draft model 110 online to a particular user, task, target model, or a combination thereof. Here, for example, a first LoRA module 710-1 (including LoRA matrices A₁ and B₁) may be attached to the draft model 110 for a user/task/target model 1, a second LoRA module 710-2 (including LoRA matrices A₂ and B₂) may be attached to the draft model 110 for a user/task/target model 2, a third LoRA module 710-3 (including LoRA matrices A₃ and B₃) may be attached to the draft model 110 for a user/task/target model 3, and so on. As part of the online adaptation, feedback signals (e.g., token acceptance and rejection) from a given target model may be collected as training data, and the training data may be used to train the respective LoRA module 710 online to align the draft model 110 to the particular user/task/target model. In this manner, aspects herein can significantly improve the acceptance rate and thus the model efficiency.

### Example Workflow for Performing Online Adaptation of a Draft Length for a Draft Model

As noted, in traditional speculative decoding, the drafting phase generally involves autoregressively generating one sequence of candidate tokens each time. The token sequence generally has a fixed length as a hyperparameter. However, if some tokens are rejected after verification, these rejected tokens may be wasted, leading to a lower acceptance rate and, in turn, a lower efficiency.

FIG. 8 depicts an example workflow 800 for performing online adaptation of a draft length for a draft model (e.g., the draft model 110) for a particular user, task, target model, or a combination thereof, according to certain aspects of the present disclosure. In some aspects, the workflow 800 is performed by a computing system (e.g., a speculative decoding system), such as the computing system discussed above with reference to FIG. 1. In some such aspects, the workflow 800 is performed by one or more components of the computing system, such as the adaptation component 165 of the draft model 110 discussed above with reference to FIG. 1.

In the illustrated workflow 800, a module 810 may be trained, via online adaptation, to predict when the draft model 110 should stop drafting. In certain aspects, a respective module 810 may be trained for each target model 115. The module 810 may be trained to match the conditional acceptance probability in the verification stage. In certain aspects, the module 810 may be trained using a weighted loss L_{adapt} with acceptance ratios min(1, p(yᵢ)/q(yᵢ)) as labels, where L_{adapt} is a weighted loss (e.g., weighted binary cross entry (BCE) loss) between the outputs of the module 810 and acceptance ratio labels constructed from the target model p and current draft model q. Here, given the embedding of a proposed token eᵢ as input, the module 810 may control the draft length, based on the cumulative probability of at least one proposed token getting rejected and a given stopping threshold γ.

In this manner, certain aspects of the present disclosure can enable a dynamic draft length, maximizing (or at least improving) the acceptance rate while still conforming to the setup of speculative decoding. For example, the acceptance rate (#accepted tokens 830/#candidate tokens 820) can be significantly increased relative to the acceptance rate in speculative decoding techniques that use a fixed draft length. Similarly, the speedup (which is proportional to the acceptance rate) may be significantly increased relative to the speedup in speculative decoding techniques that use a fixed draft length.

### Example Workflow for Performing Online Adaptation Using an Adaptive Drafting Tree for a Draft Model

FIG. 9 depicts an example workflow 900 for performing online adaptation using an adaptive drafting tree for a draft model (e.g., the draft model 110), according to certain aspects of the present disclosure. In some aspects, the workflow 900 is performed by a computing system (e.g., a speculative decoding system), such as the computing system discussed above with reference to FIG. 1. In some such aspects, the workflow 900 is performed by one or more components of the computing system, such as the adaptation component 165 of the draft model 110 discussed above with reference to FIG. 1.

In certain aspects, to improve the generation efficiency of the draft model 110, tree sampling may be utilized when drafting tokens. For example, the draft model 110 may be configured to generate a set of draft tokens 140 that are arranged in a tree structure 910 (labeled “Candidate tree”). With tree sampling, rather than extend the current sequence one token at a time, the draft model 110 may generate a branching tree of short token sequences that represent multiple futures in parallel. The module 810 can control the size of the candidate tree that is drafted via continuous online adaptation. Based on the tree verification, one or more paths 920 of the candidate tree may be accepted.

### Example Method for Machine Learning

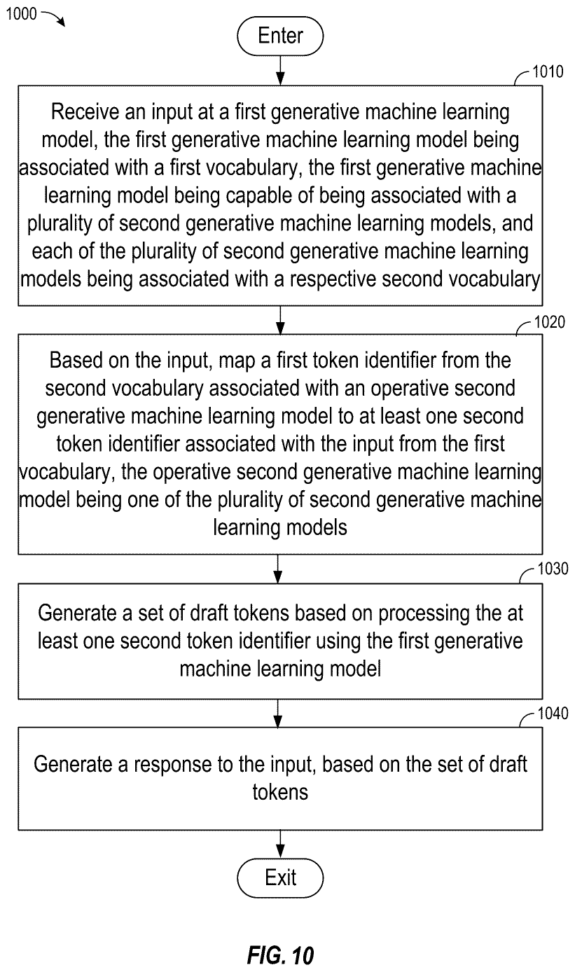

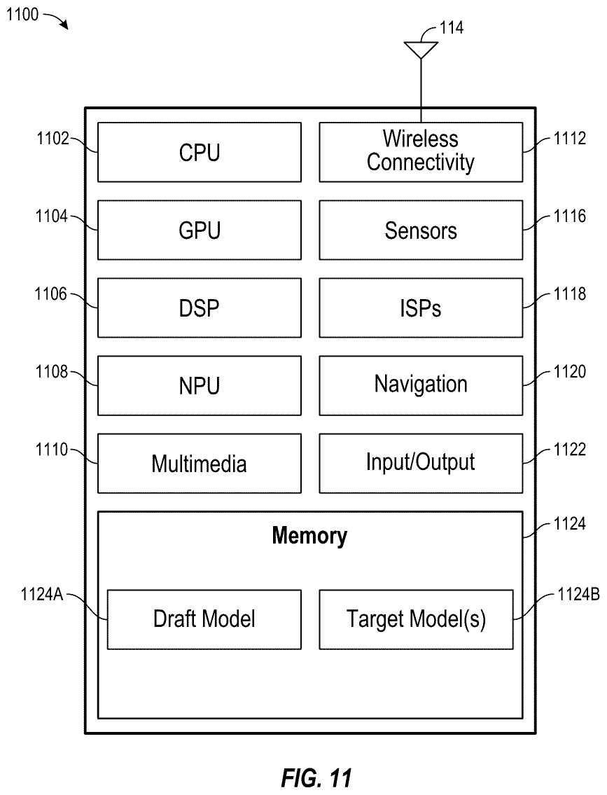

FIG. 10 is a flow diagram depicting an example method 1000 for machine learning, according to some aspects of the present disclosure. In some aspects, the method 1000 is performed by a computing system (e.g., a speculative decoding system), such as the computing system discussed above with reference to FIG. 1 and the computing system discussed with reference to FIG. 11, as illustrative examples.

At block 1010, the computing system may receive (or otherwise access) an input (e.g., prompt 105, tokens 120, and/or draft tokens 140) at a first generative machine learning model (e.g., draft model 110). The first generative machine learning model may be associated with a first vocabulary (e.g., draft vocabulary 150). The first generative machine learning model may be capable of being associated with multiple second generative machine learning models. Each of the second generative machine learning models may be associated with a respective second vocabulary.

At block 1020, based on the input, the computing system may map a first token identifier from the second vocabulary associated with an operative second generative machine learning model to at least one second token identifier associated with the input from the first vocabulary. The operative second generative machine learning model may be one of the second generative machine learning models.

At block 1030, the computing system may generate a set of draft tokens based on processing the at least one second token identifier using the first generative machine learning model.

At block 1040, the computing system may generate a response to the input, based on the set of draft tokens.

In certain aspects, the first vocabulary may include a first set of token identifiers corresponding to a first set of tokens, and the second vocabulary associated with the operative second generative machine learning model may include a second set of token identifiers corresponding to a second set of tokens. The second set of token identifiers may be different from the first set of token identifiers.

In some aspects, mapping the first token identifier to the at least one second token identifier may include: (i) determining an intersection of the first set of token identifiers and the second set of token identifiers; and (ii) mapping the first token identifier to the at least one second token identifier in the intersection of the first set of token identifiers and the second set of token identifiers. In some such aspects, the set of draft tokens may be associated with at least one third token identifier in the intersection of the first set of token identifiers and the second set of token identifiers.

In some aspects, mapping the first token identifier to the at least one second token identifier may include: (i) mapping the first token identifier to a first plurality of token identifiers in the first vocabulary, wherein the first token identifier is a composition of the first plurality of token identifiers; and (ii) associating the at least one second token identifier with the first plurality of token identifiers. In some such aspects, mapping the first token identifier to the first plurality of token identifiers may include using an n-gram mapping of compositions of token identifiers in the first vocabulary to token identifiers in the second vocabulary associated with the operative second generative machine learning model.

Additionally, in some aspects, the set of draft tokens may be associated with a second plurality of token identifiers in the first vocabulary. In some such aspects, the method 1000 may further involve: (i) mapping the second plurality of token identifiers to at least one third token identifier in the second vocabulary associated with the operative second generative machine learning model, wherein the at least one third token identifier is a composition of the second plurality of token identifiers; and (ii) associating the set of draft tokens with the at least one third token identifier. In some aspects, mapping the second plurality of token identifiers to the at least one third token identifier may include using an n-gram mapping of compositions of token identifiers in the first vocabulary to token identifiers in the second vocabulary associated with the operative second generative machine learning model.

In some aspects, the method 1000 may further involve adaptively adjusting a number of the set of the draft tokens that is generated over time, such that a first number of the set of draft tokens generated at a first instance in time is different from a second number of the set of draft tokens generated at a second instance in time. In some such aspects, the set of draft tokens may be arranged in a tree structure. Additionally, in other such aspects, the number of the set of draft tokens may be adaptively adjusted based on a likelihood of the set of draft tokens being verified by the operative second generative machine learning model.

In some aspects, the first generative machine learning model may be configured to use a respective drafting length for each of the plurality of second generative machine learning models. In some such aspects, at least one of the respective drafting lengths may be different from at least another one of the respective drafting lengths.

In some aspects, generating the response to the input may include masking at least a portion of the set of draft tokens.

In some aspects, the method 1000 may further involve adaptively updating one or more weights of one of a plurality of adapters in the first generative machine learning model over time based at least in part on input received at the first generative machine learning model. The one of the plurality of adapters may be associated with the operative second generative machine learning model.

In some aspects, at least one of the respective second vocabularies may be the same as the first vocabulary.

In some aspects, the operative second generative machine learning model may be associated with a particular inferencing task, a particular user, or a combination thereof.

In some aspects, the first generative machine learning model may be a secondary machine learning model (e.g., draft model) for speculative decoding, and each of the second generative machine learning models may be a respective primary machine learning model (e.g., target model) for speculative decoding.

The various operations of methods described above may be performed by any suitable means capable of performing the corresponding functions. The means may include various hardware and/or software component(s) and/or module(s), including, but not limited to a circuit, an application specific integrated circuit (ASIC), or a processor.

### Example Processing Systems for Speculative Decoding in Generative Artificial Intelligence Models

FIG. 11 depicts an example processing system 1100 for generating a response to a query input into a generative artificial intelligence model based on speculative decoding, such as described herein for example with respect to FIG. 10. In some aspects, the processing system 1100 may be included in a mobile device, such as a smartphone, laptop, tablet, or wearable device.

The processing system 1100 includes a central processing unit (CPU) 1102, which in some examples may be a multi-core CPU. Instructions executed at the CPU 1102 may be loaded, for example, from a program memory associated with the CPU 1102 or may be loaded from a memory partition (e.g., of a memory 1124).

The processing system 1100 also includes additional processing components tailored to specific functions, such as a graphics processing unit (GPU) 1104, a digital signal processor (DSP) 1106, a neural processing unit (NPU) 1108, and a connectivity component 1112.

An NPU, such as the NPU 1108, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1108, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 1108 is a part of one or more of the CPU 1102, the GPU 1104, and/or the DSP 1106. These may be located on a user equipment (UE) in a wireless communication system or another computing device.

In some examples, the connectivity component 1112 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 1112 may be further coupled to one or more antennas 1114.

The processing system 1100 may also include one or more sensor processing units 1116 associated with any manner of sensor, one or more image signal processors (ISPs) 1118 associated with any manner of image sensor, and/or a navigation processor 1120, which may include satellite-based positioning system components (e.g., global positioning system (GPS) or global navigation satellite system (GLONASS)) as well as inertial positioning system components.

The processing system 1100 may also include one or more input and/or output devices 1122, such as screens, touch-sensitive surfaces (including touch-sensitive displays), physical buttons, speakers, microphones, and the like.

In some examples, one or more of the processors of the processing system 1100 may be based on an advanced reduced instruction set computing (RISC) machine (ARM) or fifth generation of RISC (RISC-V) instruction set.

The processing system 1100 also includes the memory 1124, which is representative of one or more static and/or dynamic memories, such as a dynamic random access memory, a flash-based static memory, and the like. In this example, the memory 1124 includes computer-executable components, which may be executed by one or more of the aforementioned processors of the processing system 1100.

In particular, in this example, the memory 1124 includes a draft model 1124A and one or more target models 1124B. Note, in certain aspects, the memory 1124 may not include a target model(s) 1124B. The depicted components, and others not depicted, may be configured to perform various aspects of the methods described herein.

Generally, the processing system 1100 and/or components thereof may be configured to perform the methods described herein.

### Example Clauses

Implementation details of various aspects of the present disclosure are described in the following numbered clauses.

Clause 1: A processor-implemented method for machine learning, the processor-implemented method comprising: receiving an input at a first generative machine learning model, the first generative machine learning model being associated with a first vocabulary, the first generative machine learning model being capable of being associated with a plurality of second generative machine learning models, and each of the plurality of second generative machine learning models being associated with a respective second vocabulary; based on the input, mapping a first token identifier from the second vocabulary associated with an operative second generative machine learning model to at least one second token identifier associated with the input from the first vocabulary, the operative second generative machine learning model being one of the plurality of second generative machine learning models; generating a set of draft tokens based on processing the at least one second token identifier using the first generative machine learning model; and generating a response to the input, based on the set of draft tokens.

Clause 2: The processor-implemented method of Clause 1, wherein: the first vocabulary comprises a first set of token identifiers corresponding to a first set of tokens; and the second vocabulary associated with the operative second generative machine learning model comprises a second set of token identifiers corresponding to a second set of tokens, the second set of token identifiers being different from the first set of token identifiers.

Clause 3: The processor-implemented method of Clause 2, wherein mapping the first token identifier to the at least one second token identifier comprises: determining an intersection of the first set of token identifiers and the second set of token identifiers; and mapping the first token identifier to the at least one second token identifier in the intersection of the first set of token identifiers and the second set of token identifiers.

Clause 4: The processor-implemented method of Clause 3, wherein the set of draft tokens is associated with at least one third token identifier in the intersection of the first set of token identifiers and the second set of token identifiers.

Clause 5: The processor-implemented method of Clause 2, wherein mapping the first token identifier to the at least one second token identifier comprises: mapping the first token identifier to a first plurality of token identifiers in the first vocabulary, wherein the first token identifier is a composition of the first plurality of token identifiers; and associating the at least one second token identifier with the first plurality of token identifiers.

Clause 6: The processor-implemented method of Clause 5, wherein mapping the first token identifier to the first plurality of token identifiers comprises using an n-gram mapping of compositions of token identifiers in the first vocabulary to token identifiers in the second vocabulary associated with the operative second generative machine learning model.

Clause 7: The processor-implemented method in accordance with any of Clauses 5-6, wherein the set of draft tokens is associated with a second plurality of token identifiers in the first vocabulary, the processor-implemented method further comprising: mapping the second plurality of token identifiers to at least one third token identifier in the second vocabulary associated with the operative second generative machine learning model, wherein the at least one third token identifier is a composition of the second plurality of token identifiers; and associating the set of draft tokens with the at least one third token identifier.

Clause 8: The processor-implemented method of Clause 7, wherein mapping the second plurality of token identifiers to the at least one third token identifier comprises using an n-gram mapping of compositions of token identifiers in the first vocabulary to token identifiers in the second vocabulary associated with the operative second generative machine learning model.

Clause 9: The processor-implemented method in accordance with any of Clauses 1-8, further comprising adaptively adjusting a number of the set of the draft tokens that is generated over time, such that a first number of the set of draft tokens generated at a first instance in time is different from a second number of the set of draft tokens generated at a second instance in time.

Clause 10: The processor-implemented method of Clause 9, wherein the set of draft tokens is arranged in a tree structure.

Clause 11: The processor-implemented method in accordance with any of Clauses 9-10, wherein the number of the set of draft tokens is adaptively adjusted based on a likelihood of the set of draft tokens being verified by the operative second generative machine learning model.

Clause 12: The processor-implemented method in accordance with any of Clauses 1-11, wherein the first generative machine learning model is configured to use a respective drafting length for each of the plurality of second generative machine learning models.

Clause 13: The processor-implemented method of Clause 12, wherein at least one of the respective drafting lengths is different from at least another one of the respective drafting lengths.

Clause 14: The processor-implemented method in accordance with any of Clauses 1-13, wherein generating the response to the input comprises masking at least a portion of the set of draft tokens.

Clause 15: The processor-implemented method in accordance with any of Clauses 1-14, further comprising adaptively updating one or more weights of one of a plurality of adapters in the first generative machine learning model over time based at least in part on input received at the first generative machine learning model, wherein the one of the plurality of adapters is associated with the operative second generative machine learning model.

Clause 16: The processor-implemented method in accordance with any of Clauses 1-15, wherein at least one of the respective second vocabularies is the same as the first vocabulary.

Clause 17: The processor-implemented method in accordance with any of Clauses 1-16, wherein the operative second generative machine learning model is associated with a particular inferencing task, a particular user, or a combination thereof.

Clause 18: The processor-implemented method in accordance with any of Clauses 1-17, wherein: the first generative machine learning model is a secondary machine learning model for speculative decoding; and each of the plurality of second generative machine learning models is a respective primary machine learning model for speculative decoding.

Clause 19: A processing system comprising: a memory comprising processor-executable instructions; and one or more processors coupled to the one or more memories and configured to execute the processor-executable instructions and cause the processing system to perform a method in accordance with any of Clauses 1-18.

Clause 20: A mobile device comprising the processing system of Clause 19.

Clause 21: A processing system comprising means for performing a method in accordance with any of Clauses 1-18.

Clause 22: A non-transitory computer-readable medium comprising computer-executable instructions that, when executed by one or more processors of a processing system, cause the processing system to perform a method in accordance with any of Clauses 1-18.

Clause 23: A computer program product embodied on a computer-readable storage medium comprising code for performing a method in accordance with any of Clauses 1-18.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
one or more memories comprising processor-executable instructions; and
one or more processors coupled to the one or more memories and configured to execute the processor-executable instructions and cause the processing system to:
receive an input at a first generative machine learning model, the first generative machine learning model being associated with a first vocabulary, the first generative machine learning model being capable of being associated with a plurality of second generative machine learning models, and each of the plurality of second generative machine learning models being associated with a respective second vocabulary;
based on the input, map a first token identifier from the second vocabulary associated with an operative second generative machine learning model to at least one second token identifier associated with the input from the first vocabulary, the operative second generative machine learning model being one of the plurality of second generative machine learning models;
generate a set of draft tokens based on processing the at least one second token identifier using the first generative machine learning model; and
generate a response to the input, based on the set of draft tokens.

2. The processing system of claim 1, wherein:
the first vocabulary comprises a first set of token identifiers corresponding to a first set of tokens; and
the second vocabulary associated with the operative second generative machine learning model comprises a second set of token identifiers corresponding to a second set of tokens, the second set of token identifiers being different from the first set of token identifiers.

3. The processing system of claim 2, wherein to map the first token identifier to the at least one second token identifier, the one or more processors are configured to execute the processor-executable instructions and cause the processing system to:
determine an intersection of the first set of token identifiers and the second set of token identifiers; and
map the first token identifier to the at least one second token identifier in the intersection of the first set of token identifiers and the second set of token identifiers.

4. The processing system of claim 3, wherein the set of draft tokens is associated with at least one third token identifier in the intersection of the first set of token identifiers and the second set of token identifiers.

5. The processing system of claim 2, wherein to map the first token identifier to the at least one second token identifier, the one or more processors are configured to execute the processor-executable instructions and cause the processing system to:
map the first token identifier to a first plurality of token identifiers in the first vocabulary, wherein the first token identifier is a composition of the first plurality of token identifiers; and
associate the at least one second token identifier with the first plurality of token identifiers.

6. The processing system of claim 5, wherein to map the first token identifier to the first plurality of token identifiers, the one or more processors are configured to execute the processor-executable instructions and cause the processing system to use an n-gram mapping of compositions of token identifiers in the first vocabulary to token identifiers in the second vocabulary associated with the operative second generative machine learning model.

7. The processing system of claim 5, wherein:
the set of draft tokens is associated with a second plurality of token identifiers in the first vocabulary; and
the one or more processors are further configured to execute the processor-executable instructions and cause the processing system to:
map the second plurality of token identifiers to at least one third token identifier in the second vocabulary associated with the operative second generative machine learning model, wherein the at least one third token identifier is a composition of the second plurality of token identifiers; and
associate the set of draft tokens with the at least one third token identifier.

8. The processing system of claim 7, wherein to map the second plurality of token identifiers to the at least one third token identifier, the one or more processors are configured to execute the processor-executable instructions and cause the processing system to use an n-gram mapping of compositions of token identifiers in the first vocabulary to token identifiers in the second vocabulary associated with the operative second generative machine learning model.

9. The processing system of claim 1, the one or more processors are further configured to execute the processor-executable instructions and cause the processing system to adaptively adjust a number of the set of the draft tokens that is generated over time, such that a first number of the set of draft tokens generated at a first instance in time is different from a second number of the set of draft tokens generated at a second instance in time.

10. The processing system of claim 9, wherein the set of draft tokens is arranged in a tree structure.

11. The processing system of claim 9, wherein the number of the set of draft tokens is adaptively adjusted based on a likelihood of the set of draft tokens being verified by the operative second generative machine learning model.

12. The processing system of claim 1, wherein the first generative machine learning model is configured to use a respective drafting length for each of the plurality of second generative machine learning models.

13. The processing system of claim 12, wherein at least one of the respective drafting lengths is different from at least another one of the respective drafting lengths.

14. The processing system of claim 1, wherein to generate the response to the input, the one or more processors are configured to execute the processor-executable instructions and cause the processing system to mask at least a portion of the set of draft tokens.

15. The processing system of claim 1, wherein:
the one or more processors are further configured to execute the processor-executable instructions and cause the processing system to adaptively update one or more weights of one of a plurality of adapters in the first generative machine learning model over time based at least in part on input received at the first generative machine learning model; and
the one of the plurality of adapters is associated with the operative second generative machine learning model.

16. The processing system of claim 1, wherein at least one of the respective second vocabularies is the same as the first vocabulary.

17. The processing system of claim 1, wherein the operative second generative machine learning model is associated with a particular inferencing task, a particular user, or a combination thereof.

18. The processing system of claim 1, wherein:
the first generative machine learning model is a secondary machine learning model for speculative decoding; and
each of the plurality of second generative machine learning models is a respective primary machine learning model for speculative decoding.

19. A processor-implemented method for machine learning, the processor-implemented method comprising:
receiving an input at a first generative machine learning model, the first generative machine learning model being associated with a first vocabulary, the first generative machine learning model being capable of being associated with a plurality of second generative machine learning models, and each of the plurality of second generative machine learning models being associated with a respective second vocabulary;
based on the input, mapping a first token identifier from the second vocabulary associated with an operative second generative machine learning model to at least one second token identifier associated with the input from the first vocabulary, the operative second generative machine learning model being one of the plurality of second generative machine learning models;
generating a set of draft tokens based on processing the at least one second token identifier using the first generative machine learning model; and
generating a response to the input, based on the set of draft tokens.

20. A processing system for machine learning, comprising:
means for receiving an input at a first generative machine learning model, the first generative machine learning model being associated with a first vocabulary, the first generative machine learning model being capable of being associated with a plurality of second generative machine learning models, and each of the plurality of second generative machine learning models being associated with a respective second vocabulary;
means for mapping, based on the input, a first token identifier from the second vocabulary associated with an operative second generative machine learning model to at least one second token identifier associated with the input from the first vocabulary, the operative second generative machine learning model being one of the plurality of second generative machine learning models;
means for generating a set of draft tokens based on processing the at least one second token identifier using the first generative machine learning model; and
means for generating a response to the input, based on the set of draft tokens.
